(19) United States
(12) Patent Application Publication
(10) Pub. No.: US 2022/0291031 A1
(43) Pub. Date: Sep. 15, 2022

(54) MEASUREMENT TUBE OF A CORIOLIS SENSING ELEMENT, CORIOLIS SENSING ELEMENT, AND CORIOLIS METER

(71) Applicant: Endress+Hauser Flowtec AG, Reinach (CH)

(72) Inventor: Benjamin Schwenter, Breitenbac (CH)

(21) Appl. No.: 17/636,126

(22) PCT Filed: Aug. 3, 2020
(86) PCT No.: PCT/EP2020/071812

§ 371 Date: Feb. 17, 2022

(30) Foreign Application Priority Data
Aug. 19, 2019 (DE) 10 2019 122 210.9

(51) Int. Cl. G01F 1/84; G01F 15/00; G01N 9/00

(52) U.S. Cl. CPC G01F 1/8427; G01F 1/8422; G01F 15/006; G01N 9/002; G01N 2009/006

(57) ABSTRACT

A measurement tube of a Coriolis sensing element for measuring a density and a mass flow rate of a medium flowing through a measurement tube includes a measurement tube wall and a measurement tube lumen, characterized in that the measurement tube wall has a sintered ceramic material or is produced from a sintered ceramic material.

The invention relates to a measurement tube of a Coriolis sensing element, to such a Coriolis sensing element, and to such a Coriolis meter.

Coriolis meters, for example as shown in DE102015120087A1, have measurement tubes through which a medium flows whose density or mass flow rate is to be measured. Such meters have exciters for generating measurement tube vibrations, and sensors for detecting measurement tube vibrations, wherein measured values for density and mass flow rates can be derived from vibration properties. These sensors and exciters comprise electrical/magnetic or electronic components, in many instances coils and magnets, which are attached to measurement tubes and are designed to oscillate counter to one another. For example, coils can be incorporated into LTCC ceramic materials. However, such components interfere with the vibration behavior of measurement tubes, especially given small measurement tubes.

The object of the invention is therefore to propose a measurement tube, a Coriolis sensing element, and a Coriolis meter given which the influence of sensor or exciter components on measurement tube vibrations is starkly reduced.

The object is achieved by a measurement tube according to independent claim 1, by a Coriolis sensing element according to independent claim 10, and by a Coriolis meter according to independent claim 11.

In a measurement tube according to the invention of a Coriolis meter for measuring a density or a mass flow rate of a medium flowing through the measurement tube having a measurement tube wall and a measurement tube lumen, the measurement tube wall has a sintered ceramic material or is produced from a sintered ceramic material.

In one embodiment, the ceramic material is an LTCC ceramic material and comprises at least one electrical or electronic component,

wherein the component is one of the following list:

coil, temperature sensor, capacitor plate, strain sensor, electrical terminal configured for electrically connecting the aforementioned elements, electrical conductor trace.

The coil can, for example, be an integral part of an exciter or a sensor. Given a coil as an exciter component, the coil is charged with an electric current for the purpose of creating a magnetic field, and said coil can be induced to excite measurement tube vibrations by means of a further magnetic field. Given a coil as a sensor component, the coil is moved relative to a magnetic field by measurement tube vibrations, and measurable electrical voltages are thus induced which can be used for an evaluation of measurement tube vibrations.

As an alternative to a coil as a sensor component, a capacitor plate may also be used as a sensor component, wherein measurement tube vibrations cause a relative movement of the capacitor plate with respect to a further capacitor plate of a sensor, which produces a change in capacitance of a capacitor comprising both capacitor plates. The change in capacitance can be used for an evaluation of measurement tube vibrations.

Alternatively, a strain sensor can also be used for detecting measurement tube vibrations, wherein such vibrations bring about a varying expansion of the strain sensor. An ohmic resistance of the strain sensor is thereby usually measured.

Temperature sensors for the purpose of determining a media or measurement tube temperature can also be integrated into the measurement tube wall.

Advantageously, electrical terminals are provided for electrically connecting the further components integrated into the measurement tube, which are arranged in a region of low vibration amplitudes of the measurement tube vibrations. In this way, connections between electrical terminals and electrical connections, for example connecting cables, are exposed to low mechanical stresses. The components integrated into the measurement tube are thereby electrically connected to conductor traces integrated into the measurement tube.

In one embodiment, the component is attached to an outer measurement tube surface and/or integrated into the measurement tube wall and separated from the lumen by the measurement tube wall.

In one embodiment, the coil has a plurality of connecting pieces that connect partial segments and adjacent partial segments, wherein the partial segments are arranged offset with respect to a coil axis and are separated from one another by LTCC ceramic materials,

wherein partial segments are designed as layers on or in the measurement tube wall.

In one embodiment, a cross-section of an outer surface of the measurement tube wall and/or a cross-section of an inner surface of the measurement tube wall delimiting the lumen follows one of the following geometric shapes:

circle, ellipse, polygon with more than three corners, for example a rectangle or a square.

In one embodiment, the coil is produced from a metal microparticle paste, wherein the metal is especially silver and/or gold.

In one embodiment, the LTCC ceramic material has, for example, at least one of the following materials:

DuPont 948, DuPont 951, Ferro A6, Heraeus CT700, Heraeus CT800, Heraeus CT2000

In one embodiment, a cross-sectional area of the lumen is less than 5 square millimeters, and especially less than 3 square millimeters, and preferably less than 2 square millimeters.

In one embodiment, the coil has two respective terminals for connecting electrical connecting lines.

A Coriolis sensing element according to the invention of a Coriolis meter for measuring a density or a mass flow rate of a medium flowing through a measurement tube comprises:

at least one measurement tube according to the invention,

at least one exciter for generating measurement tube vibrations,

at least two sensors for detecting measurement tube vibrations,

a supporting element for supporting the measurement tube,

wherein especially at least one component of the exciter and/or at least one respective component of the sensor is an integral part of the measurement tube.

A Coriolis meter according to the invention for measuring a density or a mass flow rate of a medium flowing through a measurement tube comprises:

a Coriolis sensing element according to the invention,

an electronic measuring/operating circuit configured to operate the exciter and configured to provide measured values of the density and/or mass flow rate on the basis of the measurement tube vibrations detected by the sensors,

an electronics housing in which the electronic measuring/operating circuit is arranged.

The invention will now be described with reference to exemplary embodiments.

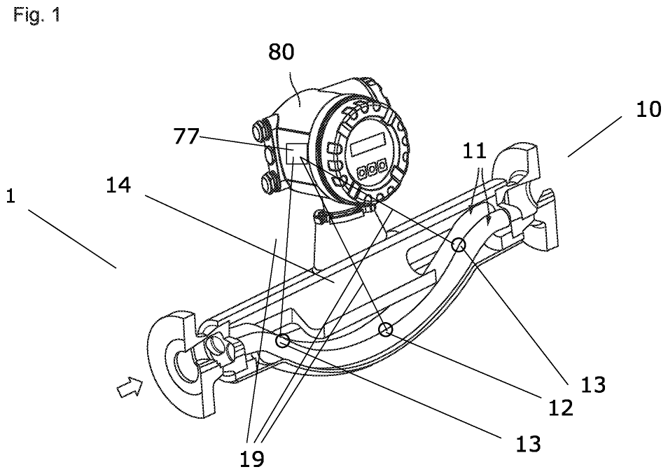

FIG. 1 describes a design of an exemplary Coriolis meter with an exemplary Coriolis sensing element;

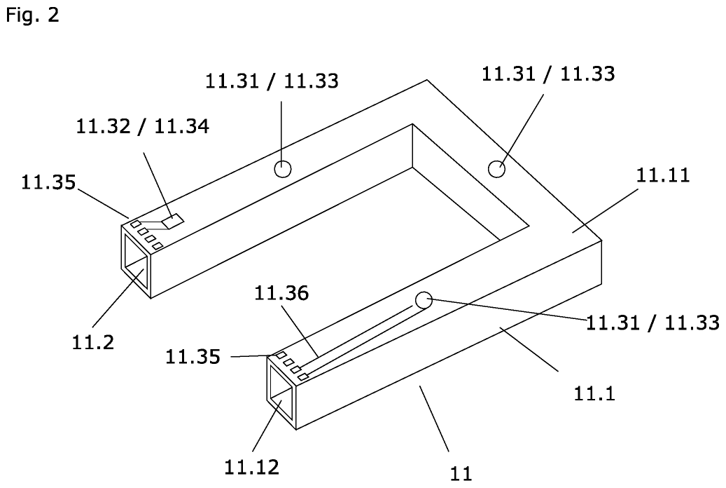

FIG. 2 shows an exemplary measurement tube according to the invention for a Coriolis meter;

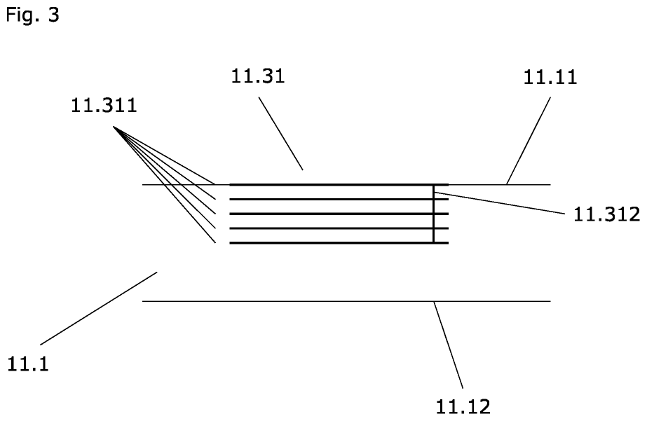

FIG. 3 schematically illustrates the arrangement of a coil in a measurement tube wall.

FIG. 1 illustrates the design of an exemplary, schematic Coriolis meter 1 with an exemplary Coriolis meter 2 according to the invention, wherein the Coriolis meter has a vibration system with two measurement tubes 11 respectively having: an inlet and an outlet, a supporting element 14 for supporting the measurement tubes; an exciter 12; and two sensors 13. The exciter is configured to excite the two measurement tubes to vibrate perpendicular to a respective measurement tube plane defined by the arc-shaped measurement tubes. The sensors are configured to detect the vibration impressed upon the measurement tubes. The Coriolis sensing element is connected to an electronics housing 80 of the Coriolis meter, which is configured to house an electronic measuring/operating circuit 77 which is configured to operate the exciter and the sensors and to determine and provide mass flow rate values and/or density values on the basis of vibration properties of the measurement tube as measured by means of the sensors. The exciter and the sensors are connected to the electronic measuring/operating circuit by means of electrical connections 19. The electrical connections 19 can respectively be grouped together by cable guides. The measurement tubes shown in FIG. 1 are provided by way of example and are not according to the invention, and serve purely for the representation a Coriolis meter.

Measurement tubes according to the invention are shown in FIG. 2. It does not represent a problem for the person skilled in the art to exchange the measurement tube shown in FIG. 1 with the measurement tubes shown in FIG. 2 and, if necessary, to adapt the supporting element and connections to a pipe system.

FIG. 2 outlines an exemplary measurement tube 11 according to the invention which has a measurement tube wall 11.1 and a measurement tube lumen 11.2, wherein the measurement tube wall has a sintered ceramic material or is produced from a sintered ceramic material. Sintered measurement tubes have the advantage that a measurement tube geometry can be designed in many ways. A cross-section of an outer measurement tube surface 11.11 of the measurement tube wall and a cross-section of an inner measurement tube surface 11.12 of the measurement tube wall delimiting the measurement tube lumen can thereby be rectangular, as is shown here. However, the cross sections can also respectively follow, for example, one of the following geometric shapes: circle, ellipse, polygon with more than three corners, such as a square. Such cross-sections can also be designed to vary along a measurement tube center line in order, for example, to advantageously form a flow of the medium in the measurement tube or vibration properties of the measurement tube. Green bodies, i.e., starting sintering bodies, can be produced, for example, by means of 3D printing or by stacking and pressing multiple foils of a starting material. Typical green bodies thereby comprise at least one of the following materials: DuPont 948, DuPont 951, Ferro A6, Heraeus CT700, Heraeus CT800, Heraeus CT2000, wherein these materials include Al₂O₃, CaAl₂Si₂O₈, or TiO₂, for example.

A measurement tube production by means of sintering of a ceramic material is advantageous given measurement tubes in which a cross-sectional area of the measurement tube lumen is less than 5 square millimeters, and especially less than 3 square millimeters, and preferably less than 2 square millimeters. With other methods, such measurement tubes can only be manufactured in a more expensive and more complicated manner and allow less freedom in selecting the geometric design of measurement tubes.

A further advantage is that the ceramic material can be designed as an LTCC ceramic material and, as is shown in FIG. 2, may thereby comprise at least one electrical or electronic component 11.3, wherein the component is, for example, one of the following list: coil 11.31, temperature sensor 11.32, capacitor plate 11.33, strain sensor 11.34, electrical terminal 11.35 configured for electrically connecting the aforementioned elements, electrical conductor trace 11.36.

The coil can, for example, be a component of an exciter or a sensor. Given a coil as an exciter component, the coil is charged with an electric current for the purpose of creating a magnetic field, and said coil can be prompted to excite measurement tube vibrations by means of a further magnetic field. Given a coil as a sensor component, the coil is moved relative to a magnetic field by measurement tube vibrations, and measurable electrical voltages are thus induced which can be used for an evaluation of measurement tube vibrations.

As an alternative to a coil as a sensor component, a capacitor plate may also be used as a sensor component, wherein measurement tube vibrations cause a relative movement of the capacitor plate with respect to a further capacitor plate of a sensor, which produces a change in capacitance of a capacitor comprising both capacitor plates. The change in capacitance can be used for an evaluation of measurement tube vibrations.

Alternatively, a strain sensor can also be used for detecting measurement tube vibrations, wherein such vibrations bring about a varying expansion of the strain sensor.

An ohmic resistance of the strain sensor is thereby usually measured.

Temperature sensors for the purpose of determining a media or measurement tube temperature can also be integrated into the measurement tube wall.

Advantageously, electrical terminals are provided for electrically connecting the further components integrated into the measurement tube which, for example, are arranged in a region of low vibration amplitude of the measurement tube vibrations. In this way, connections between electrical terminals and electrical connections, for example connecting cables, are exposed to low mechanical stresses. The components integrated into the measurement tube are thereby electrically connected to conductor traces 11.36 integrated into the measurement tube, wherein the conductor traces can travel on the outer measurement tube surface 11.11 or in the measurement tube wall. The person skilled in the art selects the number and arrangement of such electrical terminals as they deem appropriate, and is not limited to the embodiment shown in FIG. 2 with 2 by 4 electrical terminals.

The electronic components, and especially the coils 11.31, are respectively produced by means of a metal microparticle paste, wherein the metal microparticle paste especially comprises silver and/or gold. Au5062D, Au5063D as well as Ag 5081, or Ag5082 are customary in the trade.

The microparticle paste is thereby applied to a surface of the green body corresponding to the outer measurement tube surface, or is integrated into a region of the green body corresponding to the measurement tube wall during the production of the green body. For example, the microparticle paste can be applied to films prior to pressing. The sintering takes place after completion of the green body.

A coil, or electronic components in general, can thereby be applied only to the outer measurement tube surface 11.11 or, as is diagrammed at least in FIG. 3, can be at least partially integrated into the measurement tube wall 11.1.

A Coriolis sensing element or a Coriolis meter can thereby have only one measurement tube according to the invention or also multiple such measurement tubes. If a plurality of measurement tubes are present, for example, two measurement tubes can be configured to oscillate counter to one another. In this instance, electrical components of different measurement tubes of such a measurement tube pair can together form an exciter or a sensor, for example respectively comprising two capacitor plates or two coils. The electronic measuring/operating circuit is then designed to accordingly activate the electronic components, or to accordingly read out and evaluate electrical currents and/or electrical voltages.

FIG. 3 outlines an arrangement of a coil 11.31 that is partially integrated into the measurement tube wall 11.1, wherein the coil has multiple partial segments 11.311 and connecting pieces 11.312 for the purpose of electrically connecting adjacent connecting pieces. The arrangement of the connecting pieces is hereby purely schematic; a person skilled in the art will furnish connecting pieces and partial segments as they deem appropriate. As is shown here, a partial segment can be applied to the outer measurement tube surface 11.11. However, all partial segments can also be integrated into the measurement tube wall.

### LIST OF REFERENCE SIGNS

1 Coriolis meter

10 Coriolis sensing element

11 Measuring tube

11.1 Measurement tube wall

11.11 Outer measurement tube surface

11.12 Inner measurement tube surface

11.2 Measurement tube lumen

11.3 Electronic component

11.31 Coil

11.311 Partial segment

11.312 Connecting piece

11.32 Temperature sensor

11.33 Capacitor plate

11.34 Strain sensor

11.35 Electrical terminal

11.36 Electrical conductor trace

12 Exciter

13 Sensor

14 Supporting element

77 Electronic measuring/operating circuit

80 Electronics housing

1-11. (canceled)

12. A measurement tube of a Coriolis sensing element for measuring a density or a mass flow of a medium flowing through the measurement tube,
wherein the measurement tube has a measurement tube wall and a measurement tube lumen, and the measurement tube wall has a sintered ceramic material or is produced from the sintered ceramic material.

13. The measurement tube according to claim 12,
wherein the ceramic material is an LTCC ceramic material and includes at least one electrical or electronic component,
wherein the electrical or electronic component is one of the following:
a coil, a temperature sensor, a capacitor plate, a strain sensor, an electrical terminal configured for electrically connecting the aforementioned elements, and electrical conductor trace.

14. The measurement tube according to claim 13,
wherein the component is applied to a measurement tube outer surface and/or integrated into the measurement tube wall and is separated from the measurement tube lumen by the measurement tube wall.

15. The measurement tube according to claim 13,
wherein the electrical or electronic component is a coil,
wherein the coil has a plurality of connecting pieces that connect partial segments and adjacent partial segments, wherein the partial segments are arranged offset with respect to a coil axis and are separated from one another by the LTCC ceramic materials, and
wherein partial segments are designed as layers on or in the measurement tube wall.

16. The measurement tube according to claim 12,
wherein a cross-section of an outer measurement tube surface of the measurement tube wall, and/or a cross-section of an inner measurement tube surface of the measurement tube wall delimiting the measurement tube lumen, follow one of the following geometric shapes: a circle, an ellipse, and a polygon with more than three corners.

17. The measurement tube according to claim 13,
wherein the electrical or electronic component is produced from a metal microparticle paste, wherein the metal is silver and/or gold.

18. The measurement tube according to claim 13,
wherein the LTCC ceramic material includes at least one of the following materials:
DuPont 948, DuPont 951, Ferro A6, Heraeus CT700, Heraeus CT800, and Heraeus CT2000

19. The measurement tube according to claim 12,
wherein a cross-sectional area of the measurement tube lumen is less than 5 square millimeters.

20. The measurement tube according to claim 15,
wherein the coil is respectively connected to two electrical terminals for connecting electrical connecting lines.

21. A Coriolis measurement tube of a Coriolis meter for measuring a density or a mass flow rate of a medium flowing through a measurement tube, the Coriolis measurement tube comprising:
the measurement tube having a measurement tube wall and a measurement tube lumen, wherein the measurement tube wall has a sintered ceramic material or is produced from the sintered ceramic material;
at least one exciter for generating measurement tube vibrations;
at least two sensors for detecting measurement tube vibrations; and
a supporting element for supporting the measurement tube,
wherein at least one component of the exciter and/or at least one respective component of the sensor is an integral part of the measurement tube.

22. A Coriolis meter for measuring a density or a mass flow rate of a medium flowing through a measurement tube, the Coriolis meter comprising:
a Coriolis measurement tube, including:
the measurement tube having a measurement tube wall and a measurement tube lumen, wherein the measurement tube wall has a sintered ceramic material or is produced from the sintered ceramic material;
at least one exciter for generating measurement tube vibrations;
at least two sensors for detecting measurement tube vibrations; and
a supporting element for supporting the measurement tube,
wherein at least one component of the exciter and/or at least one respective component of the sensor is an integral part of the measurement tube;
an electronic measuring/operating circuit configured to operate the exciter and configured to provide measured values of the density and/or mass flow rate on the basis of the measurement tube vibrations detected by the sensors; and
an electronics housing in which the electronic measuring/operating circuit is arranged.
